(19) United States
(12) Patent Application Publication
(10) Pub. No.: US 2013/0141759 A1
(43) Pub. Date: Jun. 6, 2013

(54) PRINTING APPARATUS, METHOD FOR CONTROLLING SAME, AND STORAGE MEDIUM

(71) Applicant: Naoki Morita, Kawasaki-shi (JP)

(72) Inventor: Naoki Morita, Kawasaki-shi (JP)

(73) Assignee: CANON KABUSHIKI KAISHA, Tokyo (JP)

(21) Appl. No.: 13/683,851

(22) Filed: Nov. 21, 2012

(30) Foreign Application Priority Data
Dec. 5, 2011 (JP) 2011-266276

(51) Int. Cl. G06F 3/12

(52) U.S. Cl. CPC G06F 3/1296
USPC 358/1.15

(57) ABSTRACT

The present printing apparatus comprises a reception unit that receives print job identification information for identifying a print job from an information processing apparatus and print data for executing a print job, and a printing unit that executes printing according to print data received by the reception unit. Also, the printing apparatus manages print job information including the print job identification information and the number of pages already printed in a print job, discards data about pages to be printed when the page number to be printed in executing printing by the printing unit is at or below the number of pages already printed in a managed print job, and causes the printing unit to execute printing when the page number to be printed exceeds the number of pages already printed.

### BACKGROUND OF THE INVENTION

1. Field of the Invention

The present invention relates to a printing apparatus, to a method for controlling this printing apparatus, and to a storage medium used in this printing apparatus.

2. Description of the Related Art

With a conventional printing system, an information processing apparatus produces a print job, sends print job data to a printing apparatus successively starting with the front of the job, and deletes the print job in the information processing apparatus when all of the data has been sent. The printing apparatus outputs printed matter by performing print control, namely, by analyzing the received data and dividing it up into pages and jobs for the management, or by printing pages successively, or by controlling when a paper jam or other such error occurs, or by performing control over all the other processing related to printing.

In the past, if an error of some kind caused a transmission failure while data for a print job was being transmitted from an information processing apparatus to a printing apparatus, after the information processing apparatus recovered from the error, data transmission of the print job was started over from the beginning. This is because it could not be ascertained on the information processing apparatus side how far the printing apparatus had properly processed the data transmitted by the information processing apparatus. And since the printing apparatus had no information to determine whether the print job whose transmission was interrupted by the error was the same as the print job transmitted after error recovery, the print job transmitted after error recovery was printed from the beginning. As a result, with a conventional printing system, if data transmission of a print job failed due to an error, and printing was started again after error recovery, a problem was that there was duplicate printing of printed pages outputted by the printing apparatus prior to the data transmission failure.

One way to solve this problem was proposed in Japanese Patent Laid-Open No. 05-233177, for example, in which the number of pages already printed by an information processing apparatus was managed along with information about the print job, and the printing apparatus was notified of the number of pages already printed when printing was restarted. More specifically, the number of pages already printed was stored in the printing apparatus, the stored value was sent to the information processing apparatus when an error occurred, and the information processing apparatus restarted the data transmission of the print job after sending the above-mentioned value to the printing apparatus at the restart of printing. With this known method, the printing apparatus discards the print output up to the page number indicated by the above-mentioned value from the front of the received print job, and prints starting from the unprinted pages, so the duplicate printing of pages can be avoided.

However, the problems discussed below are encountered with prior art. For example, with a method in which the information processing apparatus manages the number of pages already printed to match the print job, the information processing apparatus must acquire information from the printing apparatus. Thus, information cannot be acquired, and the above-mentioned method therefore cannot be used, when the cause of the error leading to transmission failure is that the cable connecting the information processing apparatus and the printing apparatus comes loose, or when the environment limits communication to just one direction, from the information processing apparatus to the printing apparatus. Therefore, if information cannot be acquired by the information processing apparatus from the printing apparatus due to a loose cable or the like, duplicate printing will occur when printing is restarted after transmission failure, and as a result, toner and paper will end up being wasted.

### SUMMARY OF THE INVENTION

The present invention enables realization of avoiding the duplicate printing of pages that have already been printed when communication with an information processing apparatus is restored after the communication has become impossible during printing.

One aspect of the present invention provides a printing apparatus capable of communicating with an information processing apparatus, comprising: a reception unit configured to receive print job identification information for identifying a print job from the information processing apparatus, and print data for executing a print job; a printing unit configured to execute printing according to print data received by the reception unit; a management unit configured to manage print job information including the print job identification information and the number of pages already printed in a print job; and a printing control unit configured to discard data about pages to be printed when the page number to be printed in executing printing by the printing unit is at or below the number of pages already printed in a print job managed by the management unit, and causes the printing unit to execute printing when the page number to be printed exceeds the number of pages already printed.

Further features of the present invention will be apparent from the following description of exemplary embodiments with reference to the attached drawings.

### BRIEF DESCRIPTION OF THE DRAWINGS

FIG. 1 is a simplified diagram of an image forming system in an embodiment.

FIG. 2 is a block diagram of the hardware configuration of an information processing apparatus 101 in an embodiment.

FIG. 3 is a block diagram of the hardware configuration of an image forming apparatus 102 in an embodiment.

FIG. 4 is a block diagram of the software configuration of an image forming system in an embodiment.

FIG. 5 is a concept diagram of the configuration of print job information managed by a print job information manager 460 in an embodiment.

FIG. 6 is a flowchart of print execution processing performed by the information processing apparatus 101 in an embodiment.

FIG. 7 is a flowchart of print job start notification processing by a print job start notification unit 441 in an embodiment.

FIGS. 8A and 8B are a flowchart of processing when a controller 450 performs reception in an embodiment.

FIG. 9 is a flowchart of processing to hold print job information in the print job information manager 460 in an embodiment.

FIG. 10 is a flowchart of processing to delete print job information in the print job information manager 460 in an embodiment.

FIG. 11 is a flowchart of processing to add the number of pages already printed to the print job information manager 460 in an embodiment.

FIGS. 12A and 12B are a flowchart of printing control processing by a page printing controller 470 in an embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Configuration of Image Forming System

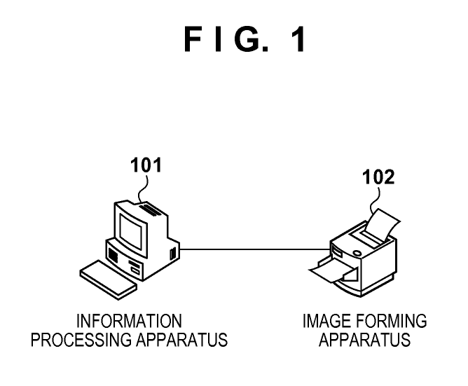

First, the image forming system in this embodiment will be described through reference to FIG. 1. 101 in the drawings is an information processing apparatus, and 102 is an image forming apparatus. The information processing apparatus 101 is connected via a USB, a network, or the like so as to be able to communicate with the image forming apparatus 102. With this image forming system, when image data is received from the information processing apparatus 101 along with image formation instructions, the image forming apparatus 102 uses the received image data to successively form images on a recording medium. The image forming apparatus 102 will be described below as an example of a printing apparatus, but the present invention is not limited to this, and can be applied to any apparatus having a printing function.

Configuration of Information Processing Apparatus

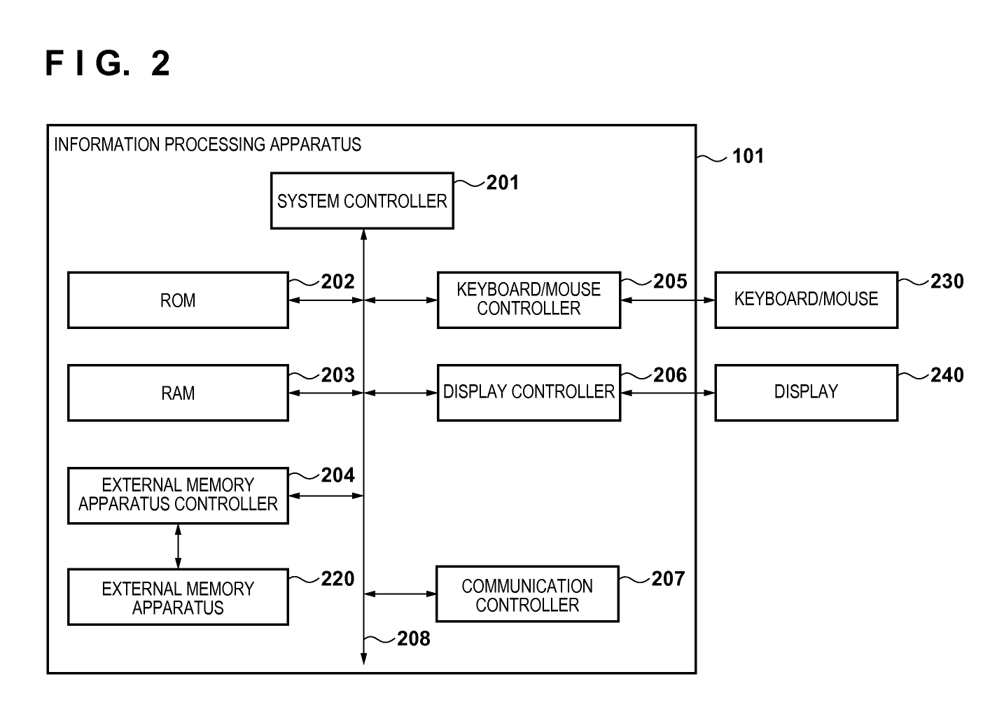

Next, the hardware configuration of the information processing apparatus 101 in this embodiment will be described through reference to FIG. 2. The information processing apparatus 101 comprises a system controller 201, a ROM 202, a RAM 203, an external memory apparatus controller 204, a keyboard/mouse controller 205, a display controller 206, a communication controller 207, and an external memory apparatus 220. The information processing apparatus 101 is also comprises a keyboard/mouse 230 and a display 240 as input/output devices.

The system controller 201 is a CPU or other such processing apparatus, and comprehensively controls the various processing performed by the information processing apparatus 101. The ROM 202 is a nonvolatile memory apparatus, and stores the various control programs and initial setting values of the information processing apparatus 101. The RAM 203 is a volatile memory apparatus, and is used as a work area for the various processing performed by the information processing apparatus 101. In this embodiment, software had by the information processing apparatus 101 is read and executed from the ROM 202, the external memory apparatus 220 (discussed below), or the like to the RAM 203. The external memory apparatus controller 204 controls input/output from and to a hard disk, CD, DVD, or other such external memory apparatus 220, for example.

The keyboard/mouse controller 205 monitors input from the keyboard/mouse 230 connected to the information processing apparatus 101, and sends input information to the system controller 201. The display controller 206 controls the output of the display 240 under control from the system controller 201. The communication controller 207 is a USB, network or other such connector and a control apparatus thereof, and controls external input/output under the control of the system controller 201. A system bus 208 is a bus inside the information processing apparatus 101 in which the above-mentioned system controller 201, ROM 202, RAM 203, external memory apparatus controller 204, keyboard/mouse controller 205, display controller 206, and communication controller 207 are arranged.

Configuration of Image Forming Apparatus

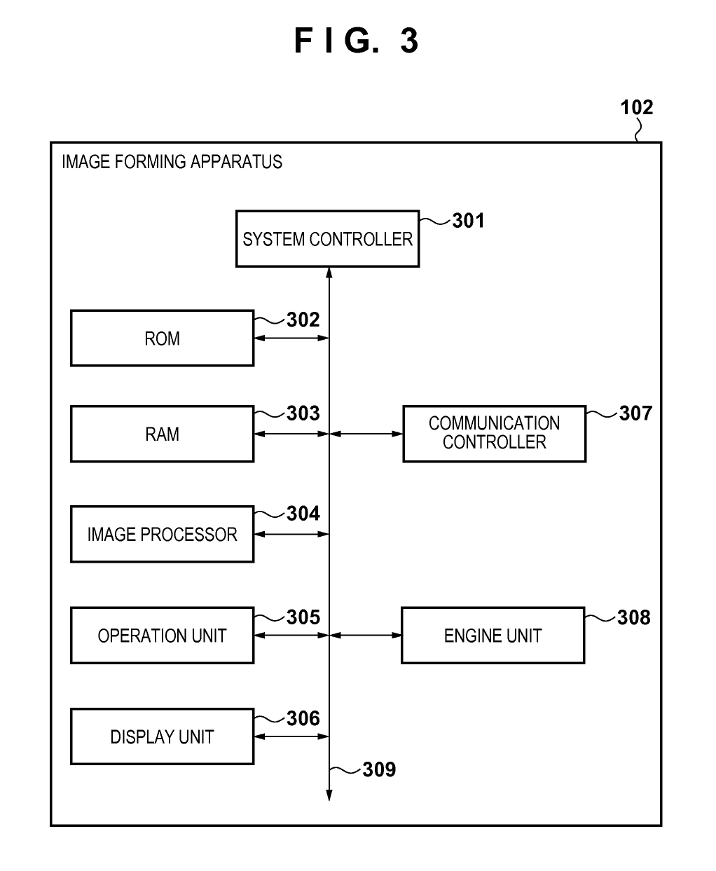

Next, the hardware configuration of the image forming apparatus 102 in this embodiment will be described through reference to FIG. 3. The image forming apparatus 102 comprises a system controller 301, a ROM 302, a RAM 303, an image processor 304, an operation unit 305, a display unit 306, a communication controller 307, and an engine unit 308.

The system controller 301 is a CPU or other such processing apparatus, and comprehensively executes the various processing performed by the image forming apparatus 102. The system controller 301 also has an apparatus for serial communication with the engine unit 308. The ROM 302 is a nonvolatile memory apparatus, and stores the various control programs and initial setting values of the image forming apparatus 102. In this embodiment, software had by the image forming apparatus 102 is recorded to this ROM 302, and is stored in the RAM 303 and executed as needed. The RAM 303 is a volatile memory apparatus, and is used as a work area for the various processing performed by the image forming apparatus 102. In this embodiment, software had by the image forming apparatus 102 is realized by reading control programs stored in the ROM 302, etc. to the RAM 303, and executing these programs.

The image processor 304 is an ASIC or other such integrated circuit, and performs various image processing under control by the system controller 301. The operation unit 305 is a button or other such input apparatus, and the system controller 301 constantly monitors its input state. The display unit 306 is an LCD or other such display apparatus, and performs display under the control of the system controller 301. The communication controller 307 is a USB, network or other such connector and a control apparatus thereof, and controls external input/output under the control of the system controller 301.

The engine unit 308 has apparatus for actually printing images on paper, such as a paper conveyance system, a laser beam control system, and a fixing device system, as well as a detection apparatus that detects when printing is successful, when an error occurs, etc., a serial communication apparatus for communicating with the system controller 301, and so forth. A system bus 309 is a bus inside the image forming apparatus 102 in which the above-mentioned system controller 301, ROM 302, RAM 303, image processor 304, operation unit 305, display unit 306, communication controller 307, and engine unit 308 are arranged.

Software Configuration in Image Forming System

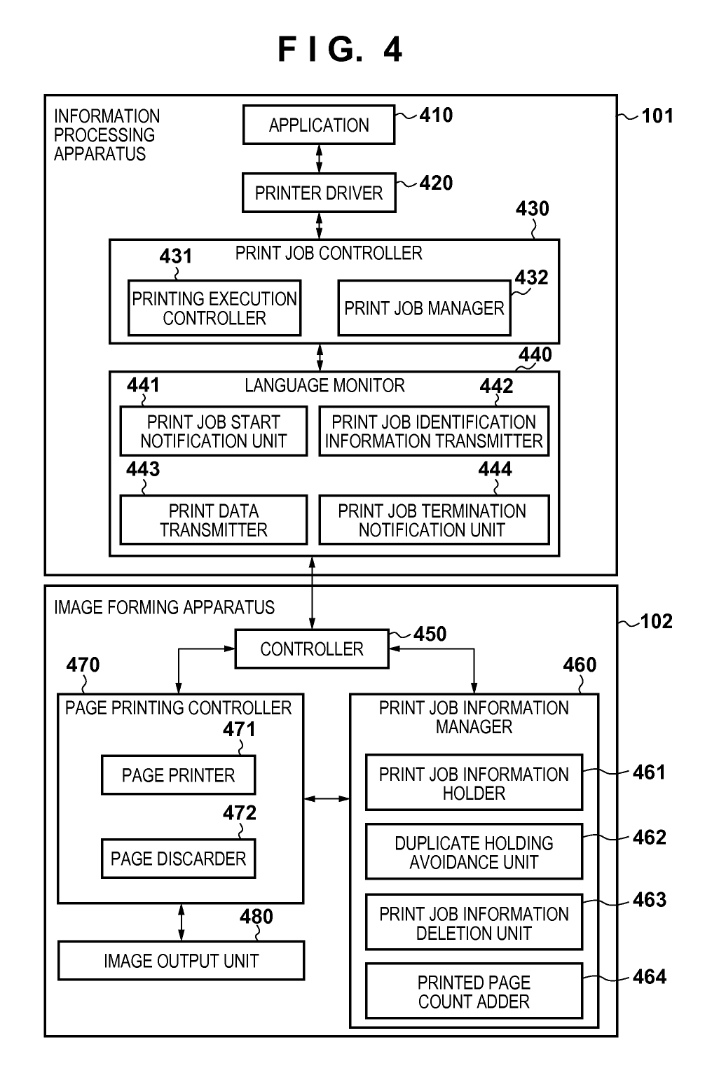

Next, an example of the software configuration in the image forming system of this embodiment will be described through reference to FIG. 4. Various components will be described as software here, but the present invention is not limited to this, and the various components may be realized by hardware or by a combination of hardware and software. The information processing apparatus 101 includes an application 410, a printer driver 420, a print job controller 430, and a language monitor 440. The print job controller 430 includes a printing execution controller 431 and a print job manager 432. The language monitor 440 includes the print job start notification unit 441, a print job identification information transmitter 442, a print data transmitter 443, and a print job termination notification unit 444.

This software is all recorded to the external memory apparatus 220, and is read as needed to the RAM 203 and executed by the system controller 201. The application 410 is an application used by the user. For instance, the user can direct via the application 410 that printing be started.

The printer driver 420 provides a user interface for making various print settings when the user wants to direct printing through the application 410. The printer driver 420 also produces a print job under a print command from the application 410, and registers the produced print job in the print job manager 432 (discussed below). The print job controller 430 performs execution control over the management and printing of print jobs. This will be described in more detail in the discussion of the printing execution controller 431 and the print job manager 432 below.

The printing execution controller 431 performs printing by sending a print job start notification, print data, and a print job termination notification through the language monitor 440 to the controller 450, for the print job for which a print command has been received from the print job manager 432. Also, when printing ends, the printing execution controller 431 deletes the print job that was being printed. The print job manager 432 holds a print job registered in the printer driver 420, decides on the job to be printed from among the print jobs being held, and notifies the printing execution controller 431. The print job manager 432 also manages information related to print jobs, such as a number for managing a print job (hereinafter referred to as a job ID), a print job name, the name of the user executing the print job, and the print job registration time. The job ID is a unique value issued by the print job manager 432 when a print job is registered, and duplicate numbers for identifying print jobs are not to be issued. The print job name and user name are received from the printer driver 420 when a print job is registered, and the registration time is acquired by asking the operating system (hereinafter referred to as OS) of the information device (not shown) when the print job is registered.

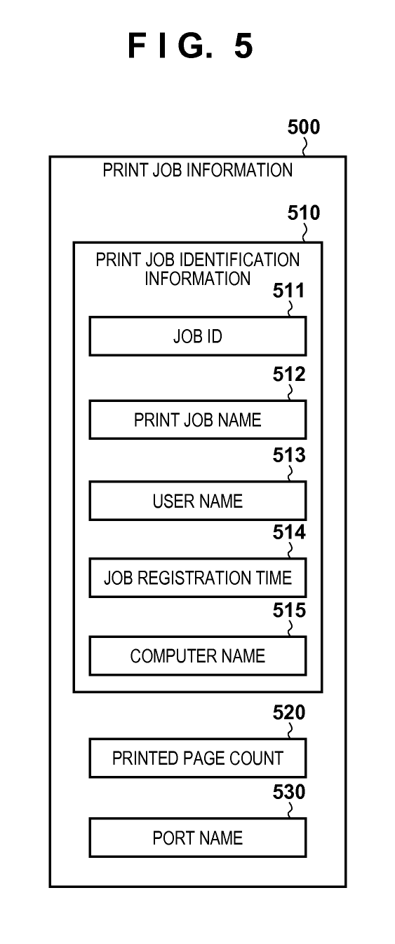

The language monitor 440 performs various communication with the controller 450 of the image forming apparatus 102 by utilizing the communication controller 207. The print job start notification unit 441 receives a print job start notification from the printing execution controller 431, and sends a print job start notification to the controller 450. The print job identification information transmitter 442 acquires print job identification information, which is information for uniquely identifying a print job, by asking the OS or the print job manager 432, and sends the print job identification information to the controller 450. In this embodiment, “print job identification information” shall include the above-mentioned job ID had by the print job manager 432, the print job name, the name of the user executing the print job, the print job registration time, and the name of the computer of the information processing apparatus had by the OS. This will be described in more detail through reference to FIG. 5.

The print data transmitter 443 receives print job data sent from the printing execution controller 431, and sends the received print job data to the controller 450. The print job termination notification unit 444 receives a print job termination notification from the printing execution controller 431, and sends the print job termination notification to the controller 450.

The image forming apparatus 102 comprises the controller 450, the print job information manager 460, the page printing controller 470, and an image output unit 480. The print job information manager 460 comprises a print job information holder 461, a duplicate holding avoidance unit 462, a print job information deletion unit 463, and a printed page count adder 464. The page printing controller 470 comprises a page printer 471 and a page discarder 472.

The controller 450 performs processing according to communication content and communication control with the language monitor 440 featuring the communication controller 307. More specifically, it performs analysis of received print data, holding of analyzed page information in the RAM 303, transmission of print job identification information to the print job information holder 461, notification to the print job information deletion unit 463 that a print job termination notification has been received, and so forth. The controller 450 also detects, through the communication controller 307, information related to communication, such as the occurrence of a communication error due to a loose cable, and notifies the page printing controller 470, etc., of what was detected, as needed.

In this embodiment, when print job identification information is sent to the print job information holder 461, the port name where the print job identification information was received is also transmitted. The port name is a USB, network, or the like, for example. The controller 450 acquires the receiving port name from the communication controller 307. The print job information manager 460 manages the received print job identification information along with the number of printed pages of the print job indicated by this print job identification information, as print job information 500.

The print job information holder 461 produces the print job information 500 along with the print job identification information received from the controller 450, the number of pages already printed, and the port name, and stores this information in the RAM 303. This is illustrated in detail in FIG. 5, which is discussed below. Let us assume that the print job information 500 can include a plurality of sets of information. The maximum number that can be stored is preset, and if new information will exceed this maximum number, information is deleted starting with the oldest. The user can change this maximum number as desired using the operation unit 305 or the like.

When the print job information holder 461 receives print job identification information, the duplicate holding avoidance unit 462 confirms whether or not this print job identification information is the same as the print job identification information received among the print job information 500 stored in the print job information holder 461. If the print job identification information is determined to be the same, the duplicate holding avoidance unit 462 discards the received print job identification information, without the print job information 500 being produced or held by the print job information holder 461 as discussed above. This is to prevent duplicate information from being held and then printed redundantly.

When a print job termination notification is received from the controller 450, the print job information deletion unit 463 deletes from the RAM 303 any print job information having print job identification information corresponding to the print job in question. The printed page count adder 464 functions as an update unit, and when a notification indicating that the printing of a page has terminated normally is received from the page printer 471, the printed page count adder 464 adds one to the value of a printed page count 520 had by the print job information 500 corresponding to the print job to which the above-mentioned page belongs.

The page printing controller 470 successively prints the pages that the controller 450 has put in the RAM 303. The page printer 471 sends the pages held in the RAM 303 one page at a time, in page number order, to the image output unit 480. The page printer 471 also deletes the above-mentioned page information from the RAM 303 if a notification has been received to the effect that the printing of the pages sent from the image output unit 480 has terminated normally. The printed page count adder 464 is notified that these pages have been properly printed. The page discarder 472 moves just before the page printer 471 sends the pages to the image output unit 480, and acquires the value of the printed page count 520 had by the print job information 500 corresponding to the print job to which the pages belong. The page discarder 472 then compares the acquired value to the page number of the page being printed, and if the page number is at or below the acquired value, transmission to the image output unit 480 is suspended, and the above-mentioned page information is deleted from the RAM 303. The image output unit 480 controls printing at the engine unit 308, and forms images according to various commands and the pages of the received print job. It also detects whether or not the page image formation has terminated normally, and sends the detection result to the page printing controller 470.

Print Job

Next, an example of print job information managed by the print job information manager 460 in this embodiment will be described through reference to FIG. 5. The print job information 500 is information produced by the print job information holder 461, and includes print job identification information 510, the printed page count 520, and the port name 530. The print job identification information 510 includes a job ID 511, a print job name 512, a user name 513, a job registration time 514, and a computer name 515. These types of information are just examples, and other information may be included depending on the specifications of the image forming system and so forth.

The print job identification information 510 is information sent from the print job identification information transmitter 442, and allows a print job to be uniquely identified. The job ID 511, the print job name 512, the user name 513, the job registration time 514, and the computer name 515 are information related to a print job had by the print job manager 432 and the OS, just as discussed in the description of the print job manager 432 above.

The printed page count 520 is a value that records up to which page was printed properly in the print job indicated by the print job identification information 510. The printed page count 520 is set to zero during the production of the print job information 500, and is incremented by 1 by the above-mentioned printed page count adder 464. The port name 530 is the name of the port where the controller 450 received print job identification information from the information processing apparatus 101, for example.

Print Execution Processing

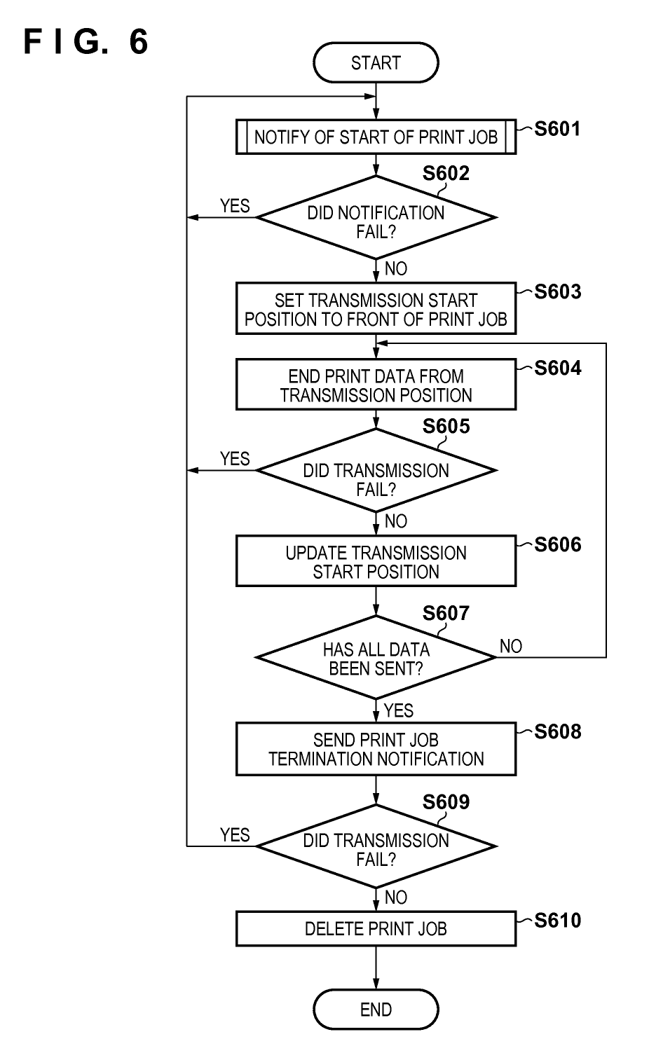

Next, print execution processing performed by the information processing apparatus 101 in this embodiment will be described through reference to FIG. 6. The processing described below is accomplished when the system controller 201 reads to the RAM 203 and executes a control program stored in the ROM 202, the external memory apparatus 220, or the like. The trigger that starts the following processing is when the printing execution controller 431 is command to execute the printing of a print job by the print job manager 432.

First, before describing the various steps below, an overview will be given of the data transmission of a print job by the information processing apparatus 101 in this embodiment. In this embodiment, when sending data for a print job to the image forming apparatus 102, the information processing apparatus 101 does not send it in page units, but instead segments all the data that makes up the print job into a predetermined transmission size (discussed below) and successively transmits these segments. More precisely, when starting the data transmission of a print job, the information processing apparatus 101 sends data equivalent to just the transmission size from the transmission start position, where this transmission start position is the front of all the data that makes up the print job. If the transmission is successful, the information processing apparatus 101 shifts the transmission start position by one transmission size unit, and sends data again from the transmission start position. This is repeated until all of the data for the print job has been sent. If the transmission fails, the transmission start position is returned to the front of all the data for the print job, and processing is redone. The above-mentioned transmission size is basically a set value, and the size of untransmitted data shall be considered as the transmission size only when the size of untransmitted data for the print job does not satisfy a certain value. Of course, the method proposed in this embodiment will be effective even if the transmission size is defined other than it is above.

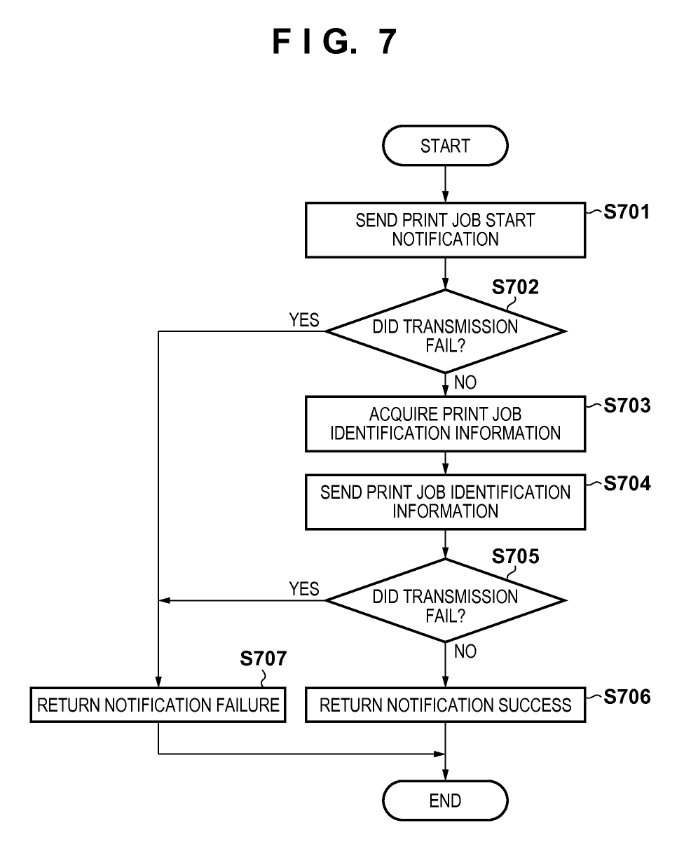

In step S601, the printing execution controller 431 notifies the print job start notification unit 441 of the start of a print job, and the processing proceeds to step S602. The processing of the print job start notification unit 441 upon receipt of this notification will be discussed below through reference to FIG. 7. In step S602, the printing execution controller 431 determines whether or not the result of notification performed by the print job start notification unit 441 was failure. If the notification failed, the processing returns to step S601, and if it succeeded, the processing proceeds to step S603.

In step S603, the printing execution controller 431 matches the transmission start position of print data to the front of all the data of the print job, and in step S604 the print data is sent from the transmission start position to the print data transmitter 443 in an amount equivalent to the transmission size. The print data transmitter 443 sends the received print data to the controller 450, and the processing proceeds to step S605.

In step S605, the print data transmitter 443 determines whether or not the transmission failed in step S604. If the transmission failed, the processing returns to step S601, and if it succeeded, the processing proceeds to step S606. In step S606, the printing execution controller 431 updates the transmission start position, that is, shifts the transmission start position to the rear by an amount equivalent to the transmission size, and the processing proceeds to step S607. In step S607, the printing execution controller 431 determines whether or not all of the data belonging to the print job was sent. If it was sent, the processing proceeds to step S608, and if there is still untransmitted data, the processing returns to step S604.

In step S608, the printing execution controller 431 notifies the print job termination notification unit 444 of the termination of the print job. Upon receiving this notification, the print job termination notification unit 444 sends a print job termination notification to the controller 450, and the processing proceeds to step S609. In step S609, the print job termination notification unit 444 determines whether or not the transmission failed in step S608. If the transmission failed, the processing returns to step S601, and if it succeeded, the processing proceeds to step S610. In step S610, the printing execution controller 431 deletes the print job that was being printed, and this processing is terminated.

Print Job Start Notification Processing

Next the print job start notification processing performed by the print job start notification unit 441 in this embodiment will be described through reference to FIG. 7. The processing described below is accomplished when the system controller 201 reads to the RAM 203 and executes a control program stored in the ROM 202, the external memory apparatus 220, or the like. In step S601 described above, the trigger that starts the processing is when the print job start notification unit 441 is notified of the start of a print job by the printing execution controller 431.

In step S701, the print job start notification unit 441 sends the controller 450 of the image forming apparatus 102 the notification of the start of a print job received from the printing execution controller 431, and the processing proceeds to step S702. In step S702, the print job start notification unit 441 determines whether or not the transmission failed in step S701. If it failed, the processing proceeds to step S707, and if it succeeded, the processing proceeds to step S703. In step S703, the print job start notification unit 441 directs the print job identification information transmitter 442 to transmit print job identification information. The print job identification information transmitter 442 acquires print job identification information. More specifically, the print job identification information transmitter 442 sends a request to the OS and the print job manager 432, acquires the job ID the print job name, the user name, the print job registration time, and the computer name, and the processing proceeds to step S704.

In step S704, the print job identification information transmitter 442 sends the controller 450 the print job identification information acquired in step S703, and the processing proceeds to step S705. In step S705, the print job identification information transmitter 442 determines whether or not the transmission of print job identification information failed in step S704. If it failed, the processing proceeds to step S707, and if it succeeded, the processing proceeds to step S706.

In step S706, the print job start notification unit 441 returns a result of successful notification to the printing execution controller 431 and terminates this processing. In step S707, meanwhile, the print job start notification unit 441 returns a result of failed notification to the printing execution controller 431 and terminates this processing.

Data Reception Processing

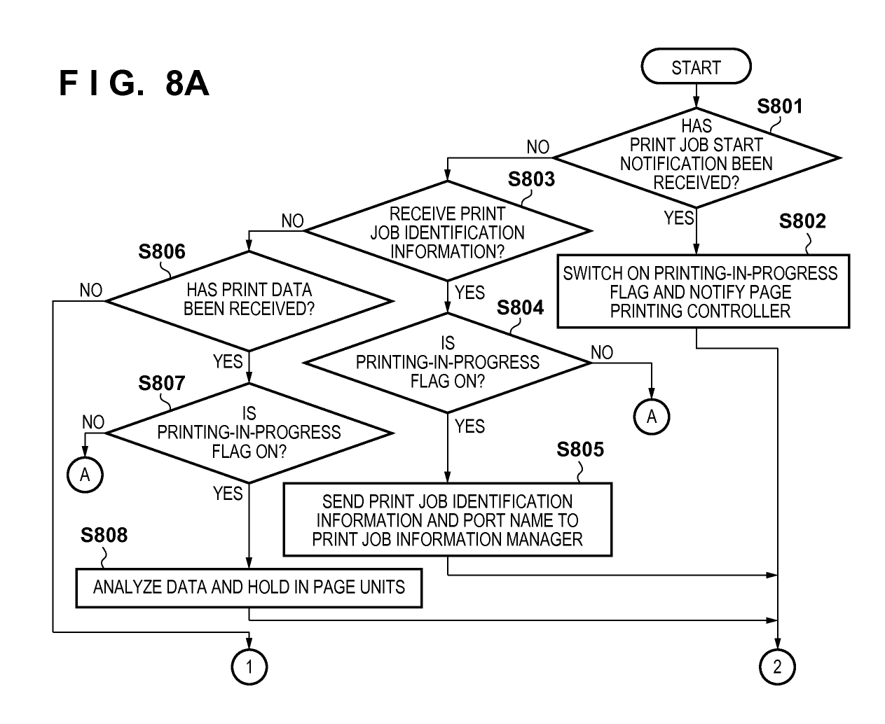

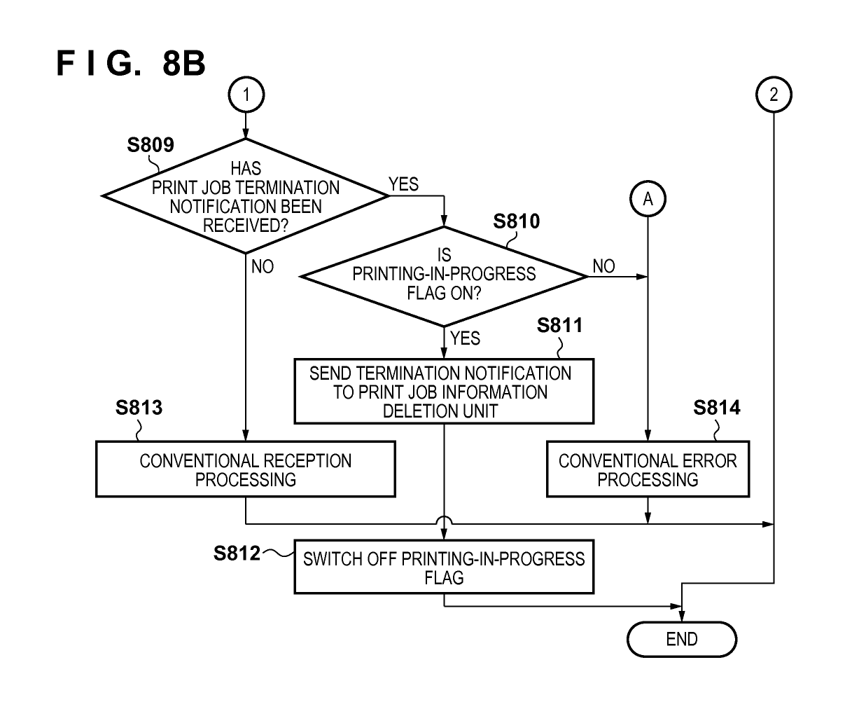

Next, the processing when the controller 450 has received data in this embodiment will be described through reference to FIGS. 8A and 8B. The processing described below is accomplished when the system controller 301 reads to the RAM 303 and executes a control program stored in the ROM 302 or the like. The trigger that starts the processing described below is when the controller 450 receives data of some kind.

In step S801, the controller 450 determines whether or not the received data is a print job start notification. If it is a print job start notification, the processing proceeds to step S802, and otherwise the processing proceeds to step S803. In step S802, the controller 450 switches on a printing-in-progress flag (discussed below). This processing is terminated after the page printing controller 470 has been notified that printing has begun. The printing-in-progress flag is a flag indicating that a print job has begun and printing is in progress, is produced when the power of the image forming apparatus 102 is switched on to actuate the system, and is stored in the RAM 303. Its initial state is off.

In step S803, the controller 450 determines whether or not the received data is print job identification information. If it is print job identification information, the processing proceeds to step S804, and otherwise the processing proceeds to step S806. In step S804, the controller 450 determines whether or not the printing-in-progress flag is on. If it is on, the processing proceeds to step S805, and if it is off, the processing proceeds to step S814. In step S805, the controller 450 sends the received print job identification information and the name of the port where the data was received to the print job information manager 460, and terminates this processing.

In step S806, the controller 450 determines whether or not the received data is print data. If it is print data, the processing proceeds to step S807, and otherwise the processing proceeds to step S809. In step S807, the controller 450 determines whether or not the printing-in-progress flag is on. If it is on, the processing proceeds to step S808, and if it is off, the processing proceeds to step S814. In step S808, the controller 450 analyzes the print data, holds information in the RAM 303 in page units, and terminates this processing. If the received print data is less than one page's worth, it is stored as temporary data in the RAM 303, and the next time print data is received, this received print data is treated as a continuation to the temporary data stored previously.

In step S809, the controller 450 determines whether or not the received data is a print job termination notification. If it is a print job termination notification, the processing proceeds to step S810, and otherwise the processing proceeds to step S813. In step S810, the controller 450 determines whether or not the printing-in-progress flag is on. If it is on, the processing proceeds to step S811, and if it is off, the processing proceeds to step S814. In step S811, the controller 450 sends a print job termination notification to the print job information deletion unit 463, and the processing proceeds to step S812. In step S812, the controller 450 sets the printing-in-progress flag to off and terminates this processing.

In step S813, the controller 450 performs conventional reception processing based on the content of the received data, and terminates this processing. This is ordinary processing that has been performed in the past, and is substantially unrelated to the present invention, and therefore this processing will not be described in detail here. In step S814, even though printing has not begun, because data has been received that is received after the start of printing, such as the reception of print data, the controller 450 decides that a situation has arisen that should not happen, executes conventional error processing, and terminates the processing. This is processing of an error that has been performed in the past, and is substantially unrelated to the present invention, and therefore this processing will not be described in detail here.

Print Job Information Holding Processing

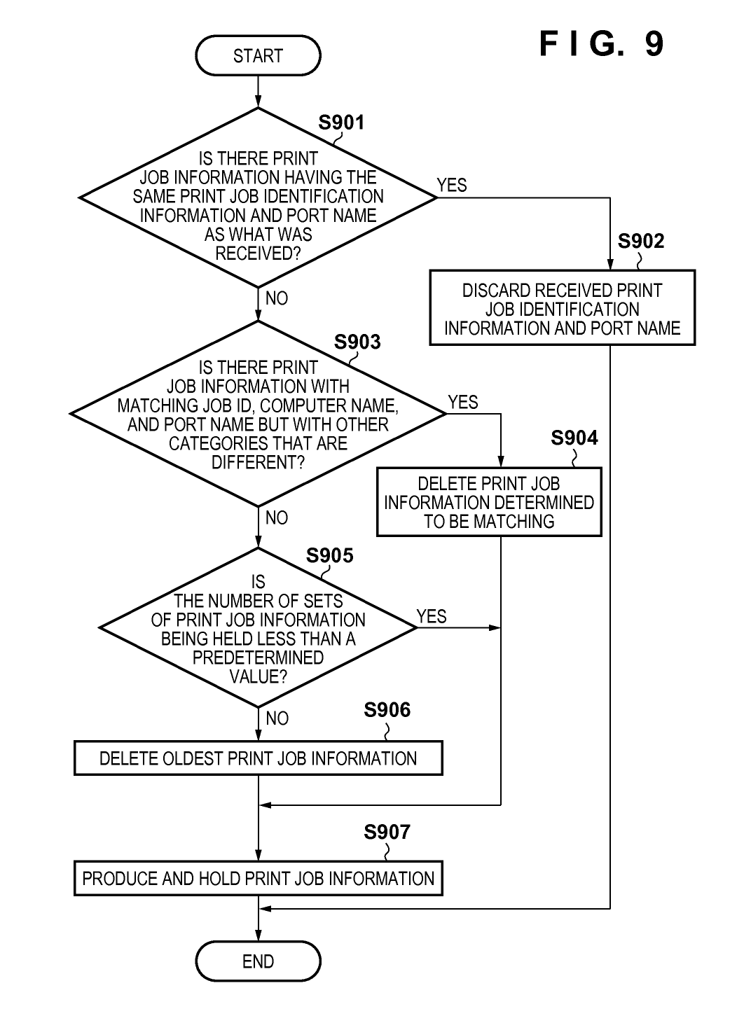

Next, the print job information holding processing performed by the print job information manager 460 in this embodiment will be described through reference to FIG. 9. The processing described below is accomplished when the system controller 301 reads to the RAM 303 and executes a control program stored in the ROM 302 or the like. The trigger that starts the processing described below is when print job identification information and a port name have been received by the print job information manager 460 from the controller 450 in step S805.

In step S901, the duplicate holding avoidance unit 462 determines whether or not the port name and the print job identification information already being held are the same as the port name and print job identification information that have been received. If they match, the processing proceeds to step S902, and if they do not match, the processing proceeds to step S903. In step S902, the duplicate holding avoidance unit 462 discards the received print job identification information and port name, and terminates this processing.

In step S903, the duplicate holding avoidance unit 462 determines whether or not print job information 500 is being held which has information matching the computer name and job ID of the received port name and print job identification information, and in which the user name, registration items, and other such information are different. If such information is being held, the processing proceeds to step S904, and otherwise the processing proceeds to step S905.

In step S904, the duplicate holding avoidance unit 462 deletes the print job information 500 determined to be held in step S903, and the processing proceeds to step S907. In step S905, meanwhile, the print job information holder 461 determines whether or not the quantity of print job information 500 currently being held exceeds a predetermined quantity. If it does exceed, the processing proceeds to step S906, and otherwise the processing proceeds to step S907.

As discussed above through reference to FIG. 4, in this embodiment it is assumed that the print job information 500 can include a plurality of sets of information. The maximum quantity that can be held is preset as the above-mentioned predetermined value, and information is deleted starting with the oldest if the maximum quantity is exceeded. In step S906, the print job information holder 461 deletes the oldest print job information 500 among the information being held. More specifically, the print job information holder 461 holds a plurality of sets of print job information 500 in a queue structure and deletes the front element in the queue, and the processing proceeds to step S907.

In step S907, the print job information holder 461 produces and holds the print job information 500. More specifically, a single set of print job information 500 shall consist of the received print job identification information 510 and port name 530, along with the printed page count 520 of the print job corresponding to the above-mentioned print job identification information 510. The print job information holder 461 manages the print job information 500 in a queue structure, the most recently produced print job information 500 is added to the end of the queue, and this processing is terminated.

Print Job Information Deletion Processing

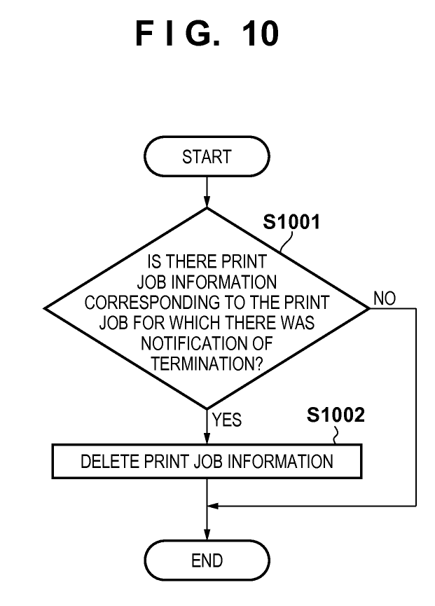

Next, the print job information deletion processing performed by the print job information manager 460 in this embodiment will be described through reference to FIG. 10. The processing described below is accomplished when the system controller 301 reads to the RAM 303 and executes a control program stored in the ROM 302 or the like. The trigger that starts the following processing is when the print job information deletion unit 463 is notified of print job termination in step S811.

In step S1001, the print job information deletion unit 463 determines whether or not print job information 500 is being held which corresponds to a print job for which there was notification of print termination. If such information is being held, the processing proceeds to step S1002, and otherwise this processing is terminated. In step S1002, the print job information deletion unit 463 deletes the print job information 500 being held, and terminates this processing.

Printed Page Count Addition Processing

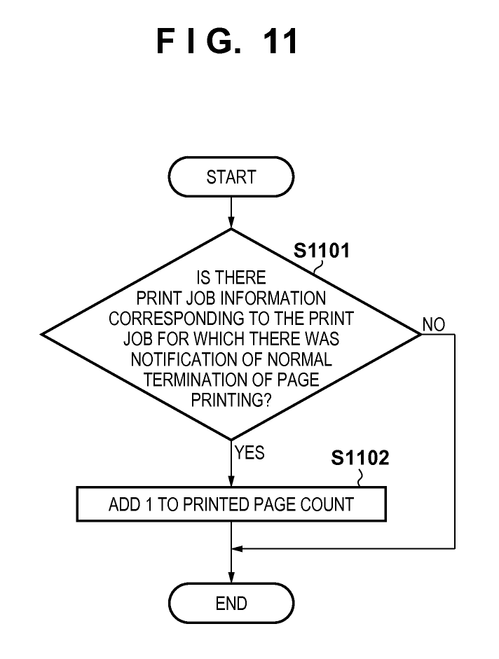

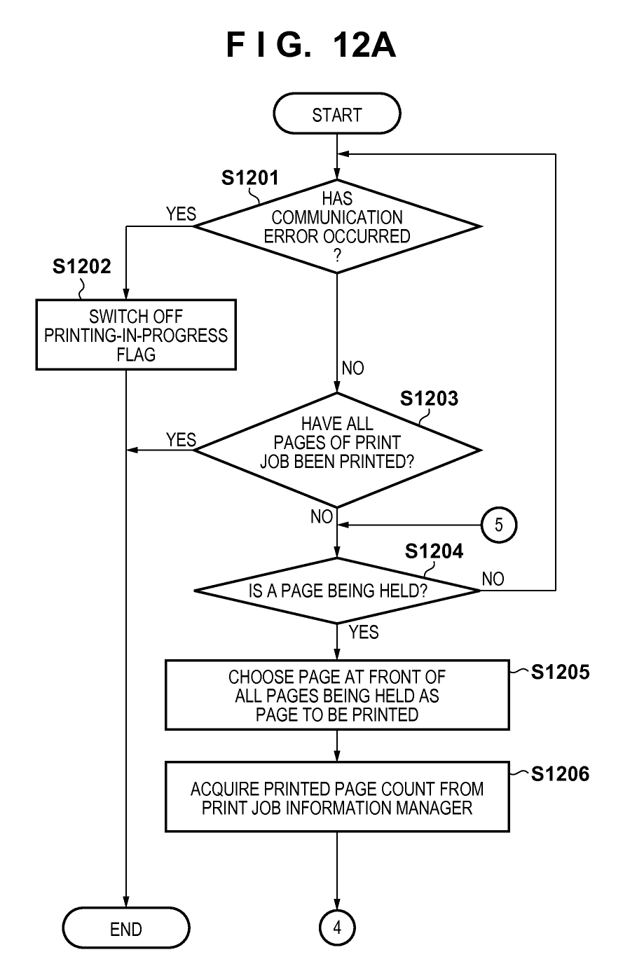

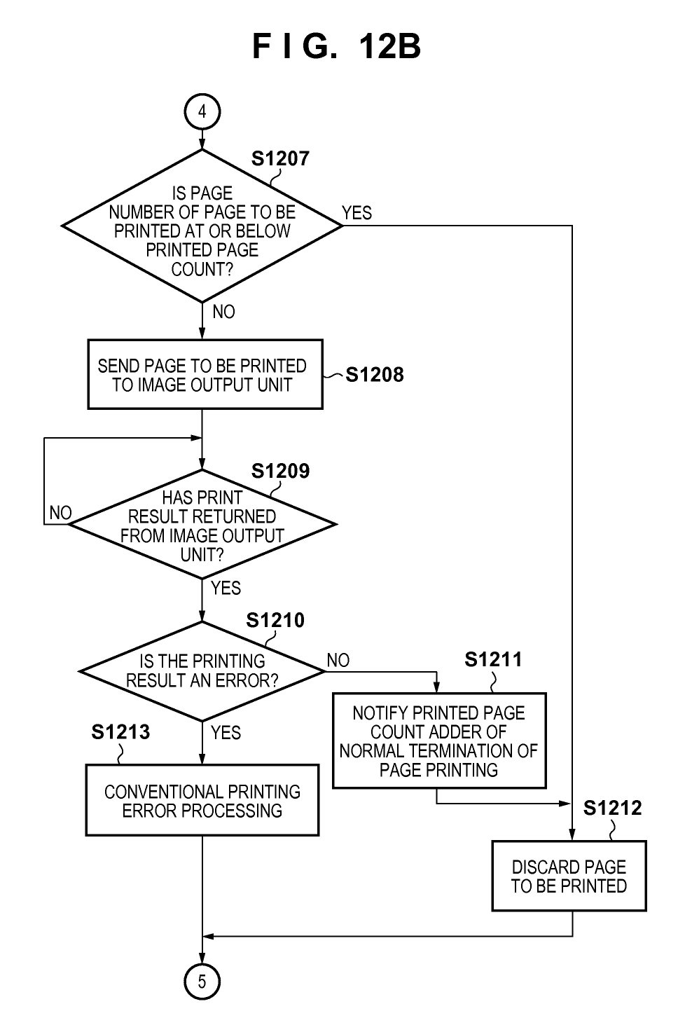

Next, the printed page count addition processing performed by the print job information manager 460 in this embodiment will be described through reference to FIG. 11. The processing described below is accomplished when the system controller 301 reads to the RAM 303 and executes a control program stored in the ROM 302 or the like. The trigger that starts the following processing is when the printed page count adder 464 is notified by the page printer 471 of the normal termination of a page in step S1211 in FIGS. 12A and 12B (discussed below).

In step S1101, the printed page count adder 464 determines whether or not print job information 500 is being held which corresponds to the print job for which there was notification of the normal termination of a page. If such information is being held, the processing proceeds to step S1102, and otherwise this processing is terminated. In step S1102, the printed page count adder 464 adds 1 to the value of the printed page count 520 had by the print job information 500 determined to be held in step S1101, and terminates this processing.

Print Control Processing

Next, the print control processing performed by the page printing controller 470 in this embodiment will be described through reference to FIGS. 12A and 12B. The processing described below is accomplished when the system controller 301 reads to the RAM 303 and executes a control program stored in the ROM 302 or the like. The trigger that starts the following processing is when the page printer 471 receives notification that printing has begun in step S802.

In step S1201, the page printer 471 asks the controller 450 whether or not an error that would prevent communication with the information processing apparatus 101, such as a loose cable, has occurred. If such an error has occurred, the processing proceeds to step S1202, and if it has not occurred, the processing proceeds to step S1203. In step S1202, the page printer 471 switches off the printing-in-progress flag and terminates this processing.

In step S1203, the page printer 471 determines whether or not all of the pages of the print job have been printed. If they have been printed, this processing is terminated, and if they have not been printed, the processing proceeds to step S1204. In step S1204, the page printer 471 confirms whether or not the pages belonging to the print job have been put in the RAM 303 by the controller 450. If they have not, the processing proceeds to step S1201, and otherwise the processing proceeds to step S1205.

In step S1205, the page printer 471 selects the front page from among the pages being held as the page to be printed, and the processing proceeds to step S1206. In step S1206, the page discarder 472 searches the print job information 500 managed by the print job information manager 460 for the print job information 500 corresponding to the print job, and acquires the value of the printed page count 520 therein, and the processing proceeds to step S1207. In step S1207, the page discarder 472 compares the value acquired in step S1206 with the page number of the page to be printed. If the page number is at or below the acquired value, the processing proceeds to step S1212, and otherwise the processing proceeds to step S1208.

In step S1208, the page printer 471 sends the page to be printed to the image output unit 480, printing is executed, and the processing proceeds to step S1209. In step S1209, the page printer 471 waits for the printing result to come back from the image output unit 480. If the result has not come back, the determination of step S1209 is repeated periodically, and if the result has come back, the processing proceeds to step S1210. In step S1210, the page printer 471 determines whether or not the result obtained in step S1209 is an error. If it is an error, the processing proceeds to step S1213, and if the termination was normal, the processing proceeds to step S1211.

In step S1211, the page printer 471 notifies the printed page count adder 464 of the normal termination of a page, and the processing proceeds to step S1212. In step S1212, the page printer 471 discards the page being printed from the RAM 303, and the processing returns to step S1204. Meanwhile, in step S1213, the page printer 471 performs conventional error processing, and the processing returns to step S1204. This is ordinary processing that has been performed in the past, and is substantially unrelated to the present invention, and therefore this processing will not be described in detail here.

As described above, even when an information processing apparatus cannot acquire information from an image forming apparatus, the duplicate printing of pages that have already been printed can be avoided when restarting printing after the failure of data transmission for a print job. This keeps paper and toner from being wasted.

### Other Embodiments

The present invention is not limited to the above embodiment, and various modifications are possible. For instance, it is conceivable that there will be situations in which the user does not wish to use the function proposed in the above embodiment, and the configuration may allow this function to be switched on or off. More specifically, the user interface presented by the printer driver 420 may include a check box for switching this function on and off. When printing is executed in a state in which the above-mentioned check box has been switched to off, the print job identification information transmitter 442 is not actuated. Consequently, the image forming apparatus 102 will receive no print job identification information, so the print job information manager 460 will not be actuated, nor will the page discarder 472. As a result, the function of duplicate printing avoidance proposed by the present invention will not work, so the operation will be the same as that of a conventional image forming system.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-266276 filed on Dec. 5, 2011, which is hereby incorporated by reference herein in its entirety.

What is claimed is:

1. A printing apparatus capable of communicating with an information processing apparatus, comprising:
a reception unit configured to receive print job identification information for identifying a print job from the information processing apparatus, and print data for executing a print job;
a printing unit configured to execute printing according to print data received by the reception unit;
a management unit configured to manage print job information including the print job identification information and the number of pages already printed in a print job; and
a printing control unit configured to discard data about pages to be printed when the page number to be printed in executing printing by the printing unit is at or below the number of pages already printed in a print job managed by the management unit, and causes the printing unit to execute printing when said page number to be printed exceeds said number of pages already printed.

2. The printing apparatus according to claim 1,
wherein the management unit comprises an update unit configured to update the number of pages already printed managed by the management unit upon notification indicating normal termination of printing from the printing unit after the printing control unit has caused the printing unit to execute printing of the pages to be printed.

3. The printing apparatus according to claim 1,
wherein the management unit comprises a deletion unit configured to delete the corresponding print job information when execution of a print job ends.

4. The printing apparatus according to claim 1,
wherein the print job information further includes a port name indicating the name of the port that received information related to the print job, and
if the received print job identification information and the port name where said print job identification information was received match already-managed information, the management unit discards said print job identification information.

5. The printing apparatus according to claim 4,
wherein the print job identification information includes a job ID for identifying a print job, a print job name indicating the name of a print job, a user name indicating the name of the user who directs the execution of a print job, a job registration time indicating the time when a print job was registered, and a computer name indicating the name of the information processing apparatus that sent a print job, and
if only the job ID and the computer name out of the received print job identification information match already-managed information, and the port name matches already-managed information, the management unit deletes the matching already-managed print job information, and produces and newly manages print job information including the received print job identification information.

6. The printing apparatus according to claim 1,
wherein the management unit further deletes the oldest print job information when a specific quantity of print job information that can be managed is exceeded in newly producing and managing the print job information.

7. A method for controlling a printing apparatus comprising a reception unit that receives print job identification information for identifying a print job from the information processing apparatus and print data for executing a print job, and a printing unit that executes printing according to print data received by the reception unit, the method comprising:
managing, by a management unit, print job information including the print job identification information and the number of pages already printed in a print job; and
having a printing control unit discard data about pages to be printed when the page number to be printed in executing printing by the printing unit is at or below the number of pages already printed in a print job managed in the managing step, and cause the printing unit to execute printing when said page number to be printed exceeds said number of pages already printed.

8. A computer-readable storage medium storing a computer program for causing a computer to execute the steps in the method for controlling a printing apparatus according to claim 7.
